(19) United States
(12) Patent Application Publication
(10) Pub. No.: US 2010/0011427 A1
(43) Pub. Date: Jan. 14, 2010

(54) Information Storage Device Having Auto-Lock Feature

(76) Inventor: Fernando A. Zayas, Loveland, CO (US)

Correspondence Address: PATTERSON & SHERIDAN, L.L.P., 3040 POST OAK BOULEVARD, SUITE 1500, HOUSTON, TX, 77056, US

(21) Appl. No.: 12/171,274

(22) Filed: Jul. 10, 2008

(51) Int. Cl. H04L 9/32; G06F 21/00

(52) U.S. Cl. 726/7; 726/2

(57) ABSTRACT

An information storage device is protected from unauthorized access by requiring periodic re-authentication of user credentials. Failure to correctly re-authenticate within a time window results in the automatic locking of the portions of the storage device that have been previously enabled for the user so that they are no longer accessible.

### BACKGROUND OF THE INVENTION

1. Field of the Invention

Embodiments of the present invention relate generally to information storage devices and, more particularly, to a method and system for protecting an information storage device from unauthorized access using an auto-lock feature.

2. Description of the Related Art

Information storage devices, such as hard disk drives of laptop and desktop computers, optical storage devices, solid state storage devices, and magnetic media, are frequently used by individuals, businesses, and government organizations to store sensitive information. Security measures commonly used to prevent unauthorized access to the information stored on such information storage devices include password protection provided by the operating system of a host platform and, in some systems, password protection of the storage device itself. For a user to gain access to a storage device, the user needs to log into the host platform with an access code or other user credential, and the host then provides access to the user to appropriate portions of the storage device.

Some host platforms employ a timed logoff feature that causes the host platform to automatically go into hibernation or sleep mode if it is not being used for a set period of time. To gain access to the host platform again, the user is required to resubmit his or her credentials. By preventing access to the host platform, access to the storage device is also blocked and, as a result, such systems provide a layer of security for the data on the storage device. This layer of security can be easily defeated, however. For example, periodic inputs from a keyboard or mouse are typically sufficient to prevent the timed logoff function of a host platform from being triggered, and a stolen computer housing the storage device can receive such periodic inputs from an unauthorized user via the mouse, the keyboard, or an appropriate USB-attached device that simulates mouse or keyboard inputs. Thus, an authorized user's authentication can remain in effect indefinitely, providing an unauthorized user unlimited access to information on the storage device.

When access to an information storage device is established from a remote computing device via a network connection and remains connected for an extended period of time, the storage device can remain in an accessible state for that entire period even if the host platform is configured with a timed logoff. The user's storage device authentication remains in effect and the storage device is available to be accessed via the network by unauthorized users.

### SUMMARY OF THE INVENTION

Embodiments of the invention protect contents of an information storage device through an auto-lock feature that is activated under certain conditions to disable access to some or all portions of the information storage device. According to one embodiment, the auto-lock feature is activated when an authenticated user of the information storage device has failed to re-authenticate his or her credentials with the information storage device within a predetermined time period.

A method for protecting contents of an information storage device, according to an embodiment of the invention, is carried out by the information storage device. This method includes the steps of authenticating a user, monitoring time elapsed from the time the user is authenticated, and disabling access to portions of the information storage device associated with the user if the time elapsed exceeds a maximum.

A computer system according to an embodiment of the invention includes a host unit, and an information storage device that is configured to: (i) enable portions of the information storage device for access when a user has been authenticated by the information storage device, and (ii) disable the portions of the information storage from being accessed if the user has not been re-authenticated within a predetermined time period. The host unit and the information storage device may be components of a laptop or desktop computer, or they may be connected over a computer network.

Embodiments of the invention further include a computer-readable storage medium comprising instructions that are executable by a controller of an information storage device to carry out the steps of authenticating a user, monitoring time elapsed from the time the user is authenticated, and disabling partitions of the information storage device associated with the user if the time elapsed exceeds a maximum.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic block diagram of a host platform and an information storage device that may be configured with an auto-lock feature.

FIG. 2 is a block diagram illustrating an embodiment of the hard disk drive in FIG. 1.

FIG. 3 is a block diagram schematically illustrating components of a printed circuit board from FIG. 2.

FIG. 4 is a block diagram schematically illustrating components of the system on chip from FIG. 3.

FIG. 5 is a flow diagram illustrating a method for enabling portions of an information storage device when a user logs in.

FIG. 6 is a flow diagram illustrating a method for disabling portions of an information storage device according to an embodiment of the invention.

For clarity, identical reference numbers have been used, where applicable, to designate identical elements that are common between figures. It is contemplated that features of one embodiment may be incorporated in other embodiments without further recitation.

### DETAILED DESCRIPTION

Embodiments of the invention contemplate a method and system for protecting an information storage device from unauthorized access by requiring periodic re-authentication of user credentials. Failure to correctly re-authenticate within a time window results in the automatic locking of portions of the storage device that have been previously enabled for the user so that they are no longer accessible. Information storage devices that may benefit from embodiments of the invention include hard disk drives (HDDs) of laptop and desktop computers, optical storage devices, solid state storage devices, and magnetic media, among others.

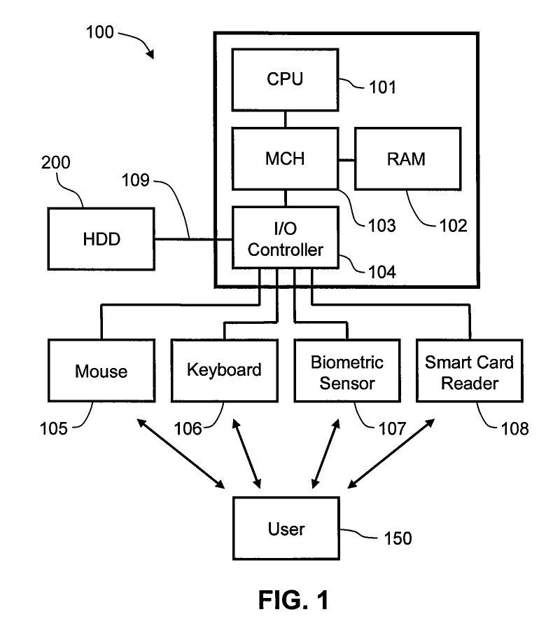

FIG. 1 is a schematic block diagram of a host platform 100 and an information storage device, HDD 200, that may be configured with an auto-lock feature, further described below, to protect the information storage device against unauthorized access. Host platform 100 may be a laptop computer, a desktop computer, or an appliance such as set-top boxes, televisions and video players, requesting access to one or more sectors of HDD 200. Alternatively, host platform 100 may be a remote computing device that accesses HDD 200 over a LAN or WAN.

In one embodiment, host platform 100 includes a central processing unit (CPU) 101, RAM 102, a memory controller hub (MCH) 103, an I/O controller hub 104, a plurality of I/O devices 105-108, and a communications link 109 with HDD 200. Host platform 100 also includes an operating system, the software component of host platform 100 that manages and coordinates operation of the hardware making up host platform 100, and provides a user interface to host platform 100. The operating system typically resides in RAM 102 during operation of host platform 100. When host platform 100 is part of a network, the operating system may be downloaded from network storage upon boot-up of host platform 100. When host platform 100 is contained in a stand-alone computer, such as a laptop or desktop, the operating system is loaded into RAM 102 from HDD 200 or other local storage medium that is part of the stand-alone computer.

CPU 101 is a processor that executes the software programs run on host platform 100. RAM 102 provides the data storage as required for the operation of CPU 101 and host platform 100. Memory controller hub 103 routes communications between CPU 101, RAM 102, I/O controller hub 104, and any graphics hardware that may be included in host platform 100, such as a graphics card. I/O controller hub 104 provides an interface with host platform 100 for I/O devices, and routes and controls data to and from the I/O devices. As illustrated in FIG. 1, host platform 100 includes a plurality of I/O devices, including HDD 200, a mouse 105, a keyboard 106, a biometric sensor 107, and a smart card reader 108. Mouse 105 and keyboard 106 provide user 150 with conventional computer interfaces to host platform 100, allowing input by user 150 of user credentials, such as user ID number and alphanumeric passwords and access codes. Biometric sensor 107 allows entry of a user biometric credential into host platform 100. For example, biometric sensor 107 may be a fingerprint scanner for entry of a user fingerprint. Other examples of biometric credentials include face, hand, and iris geometry. Smart card reader 108 is configured to accept and read a smart card, which is a pocket-sized or credit card-sized card with an embedded integrated circuit that includes an encrypted access code.

Host platform 100 is connected to HDD 200 via communications link 109. When host platform 100 is contained in a stand-alone computer, communications link 109 represents an internal bus connecting HDD 200 to CPU 101 via I/O controller hub 104. When host platform 100 is part of a network, communications link 109 includes the network connections between host platform 100 and HDD 200. In one embodiment, HDD 200 is contained in the computing device making up host platform 100, such as a laptop or desktop computer. In another embodiment, HDD 200 is physically separated from host platform 100 and is accessed remotely via a network connection established by host platform 100.

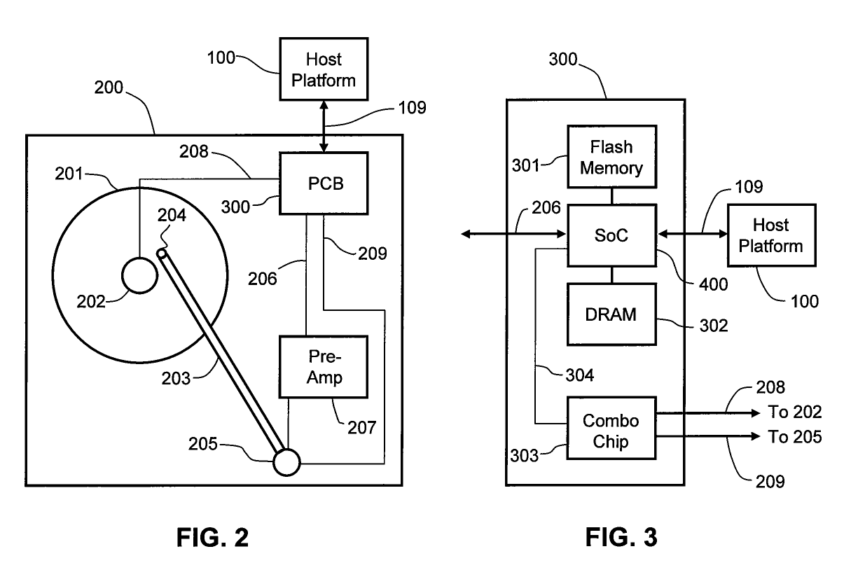

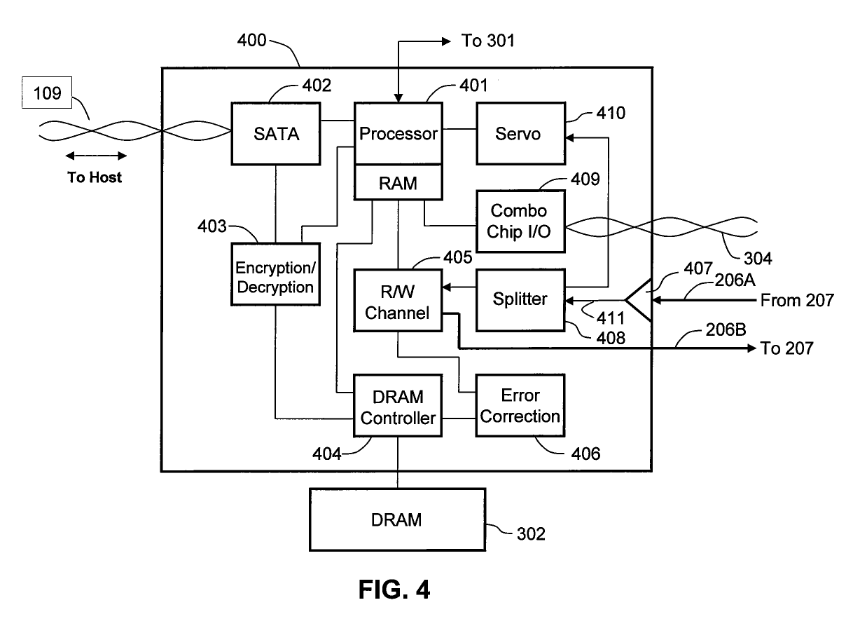

FIG. 2 is a block diagram illustrating an embodiment of HDD 200, in FIG. 1. The mechanical components of HDD 200 include a magnetic disk 201 rotated by a spindle motor 202 and a read/write head 204 disposed on the end of a suspension arm 203. Arm actuator 205 is coupled to suspension arm 203 for moving arm 203 as desired to access different tracks of magnetic disk 201. Electronic components of HDD 200 include a printed circuit board, PCB 300, and a pre-amplifier 207, the latter of which is electrically coupled to read/write head 204. Pre-amplifier 207 conditions and amplifies signals to and from read/write head 204. PCB 300 includes a system-on-chip (SoC), RAM, and other integrated circuits for operating HDD 200, and is described below in conjunction with FIGS. 3 and 4. As shown, PCB 300 is electrically coupled to pre-amplifier 207 via electrical connection 206, to spindle motor 202 via electrical connection 208, and to arm actuator 205 via electrical connection 209. PCB 300 communicates with host platform 100 via communications link 109, which may be an SATA, PATA, SCSI, or other interface cable.

FIG. 3 is a block diagram schematically illustrating components of PCB 300 from FIG. 2. PCB 300 includes an SoC 400, DRAM 302, which may be internal or external to SoC 400, flash memory 301, and a combo chip 303, which drives spindle motor 202 and arm actuator 205. Combo chip 303 also includes voltage regulators for SoC 400, pre-amplifier 207, and the motor controllers contained in SoC 400. As shown, flash memory 301 and DRAM 302 are coupled to SoC 400, which interfaces with host platform 100 via communication link 109, pre-amplifier 307 via electrical connection 206, and combo chip 303 via serial bus 304. In some embodiments, flash memory 301 resides in SoC 400. Firmware for HDD 200 resides in flash memory 301. In alternative configurations, a small portion of the firmware that is not changeable resides in a read-only memory within SoC 400 and the bulk of the firmware resides on magnetic disk 201 and loaded shortly after power up.

FIG. 4 is a block diagram schematically illustrating components of SoC 400 from FIG. 3. SoC 400 is an application-specific integrated circuit (ASIC) configured to perform the control and encryption/decryption operations necessary for HDD 200 to provide secure user access based on periodic re-authentication, to securely download firmware, and to store encrypted data on magnetic disk 201. SoC 400 includes a number of functional blocks designed to perform particular functions. Processor 401 is a microcontroller configured to control the operation of HDD 200 and includes RAM and input/output functionality for communication with the other functional blocks of SoC 400, as shown. In one embodiment, processor 401 may be configured with flash memory 301 internally, rather than positioned nearby on PCB 400. SATA block 402 is an input/output block contained in SoC 400 that sends and receives signals to and from host platform 100 via communications link 109. Combo chip I/O block 409 is an I/O block dedicated to communication between processor 401 and combo chip 303 via serial bus 304. Processor 401 is also configured to encrypt data traffic between HDD 200 and host platform 100, particularly security-related traffic, such as encryption keys. Processor 401 and/or block 403 encrypts traffic leaving HDD 200 and being transmitted to host platform 100. Host platform 100 must then decrypt such data using the appropriate encryption key before the encrypted data traffic is useable by host platform 100. Traffic is likewise encrypted from host platform 100 and HDD 200. The movement of encrypted control traffic between HDD 200 and host platform 100 uses “trusted send/trusted receive” commands. Encrypted data traffic between HDD 200 and host platform 100 uses normal host interface read/write commands.

Encryption/decryption block 403, which is under the control of processor 401, is positioned in the data path between SATA block 402 and all other components of SoC 400 to encrypt incoming data for secure storage and decrypt outgoing data for use by host platform 100. That is, encryption/decryption block 403 receives and encrypts input data from host platform 100 via SATA block 402, and decrypts and transmits output data, i.e., data accessed from HDD 200, to host platform 100 via SATA block 402. Encryption/decryption block 403 includes state machines that implement the desired encryption algorithms as well as memory for holding encryption keys and for buffering data during encryption/decryption of data traffic. In operation, encryption/decryption block 403 receives data from host platform 100 in unencrypted form. If appropriate encryption keys are provided for use with the incoming data, said data is encrypted by encryption/decryption block 403 and stored, either in DRAM 302 or on magnetic disk 201. When host platform 100 retrieves stored data, encryption/decryption block 403 decrypts the data prior to transmission by SATA block 402, so that the host receives unencrypted data.

DRAM controller 404 refreshes DRAM 302 and arbitrates the use of DRAM 302, making DRAM 302 accessible to encryption/decryption block 403, processor 401, read/write channel 405, and error correcting and generating block 406, as needed for the proper operation of HDD 200. DRAM 302 serves as a DRAM buffer for data being written to or read from magnetic disk 201 and for data received from host platform 100 after encryption. DRAM 302 may be external to SoC 400 as shown, or, alternatively, may make up one of the functional blocks contained therein. For error-free retrieval of data from magnetic disk 201, error correction block 406 applies error correction to data read from magnetic disk 201 before the data is buffered in DRAM 302 for decryption and transmission to host platform 100. In addition, when data is being written to magnetic disk 201, error correction block 406 appends information to said data to allow error correction upon retrieval of the data from magnetic disk 201.

In order for host platform 100 to retrieve data from magnetic disk 201, data is read from magnetic disk 201 by read/write head 204, conditioned by pre-amplifier 207, and carried as an analog signal by electrical connection 206A to analog-to-digital converter 407. Analog-to-digital converter 407 converts the analog signal to a digital signal 411, which is transmitted to a splitter block 408. From digital signal 411, splitter block 408 sends the appropriate servo-related data to servo block 410 for optimal control of spindle motor 202 and arm actuator 203 using motor 205. Splitter block 408 sends the data requested by host platform 100 to read/write channel 405, which routes the data through error correction block 406 to DRAM 302 for buffering until said data can be decrypted and transmitted to host platform 100.

For storage of data on magnetic disk 201 by host platform 100, encrypted data is buffered in DRAM 302 as necessary and routed through error correction block 406 and then to read/write channel 405. Read/write channel 405 then sends a digital signal via electrical connection 206B to pre-amplifier 207, which conditions and amplifies the digital signal for read/write head 204 to write the encrypted data onto magnetic disk 201. One of skill in the art will appreciate that encrypted data resides in the storage media contained in HDD 200, i.e., DRAM 302 and magnetic disk 201.

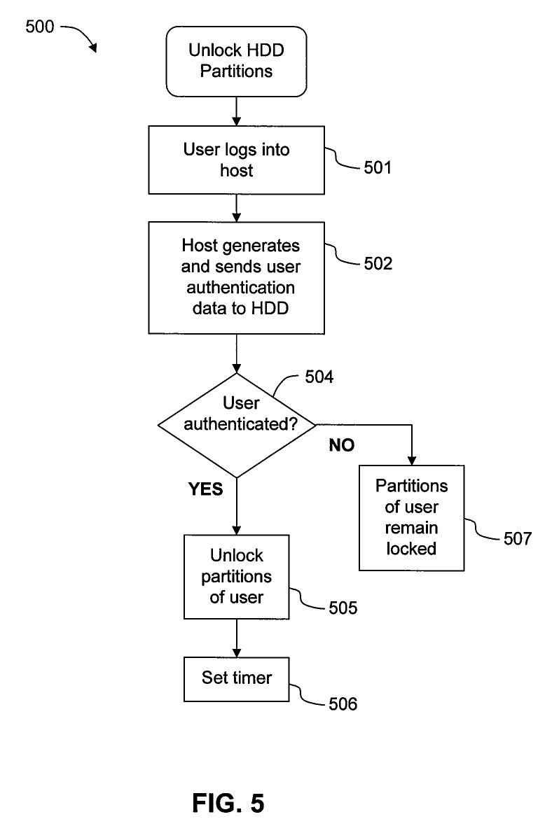

FIG. 5 is a flow diagram illustrating a method for enabling portions of an information storage device, e.g., partitions of HDD 200, when a user logs into a host, such as host platform 100. The host may be a laptop or desktop computer, or a remote computing device, e.g., a network computer or terminal, accessing the storage device over a LAN or WAN.

In step 501, a user logs into the host. The user logs into the host by providing one or more user credentials to the host, in combination with a corresponding user identification name or number. User credentials for this purpose may include an alphanumeric access code, one or more biometric credentials, such as a fingerprint scan, or a properly encoded smart card, among others. For added security, the entry of a combination of user credentials may be required for each successful login. After successful user login, flow proceeds to step 502.

In step 502, the host generates user authentication data for use in authenticating the user at the storage device and sends the user authentication data to the storage device. The host generates the user authentication data using the information that it stored as it was setting up different users for the storage device.

Step 504 is carried out by the storage device, where it determines whether the user is authenticated using the user authentication data it received from the host. User authentication may be carried out using the methods described in co-pending U.S. patent application Ser. No. 12/060,182, entitled “Storage Device and Encryption Method,” filed Mar. 31, 2008.

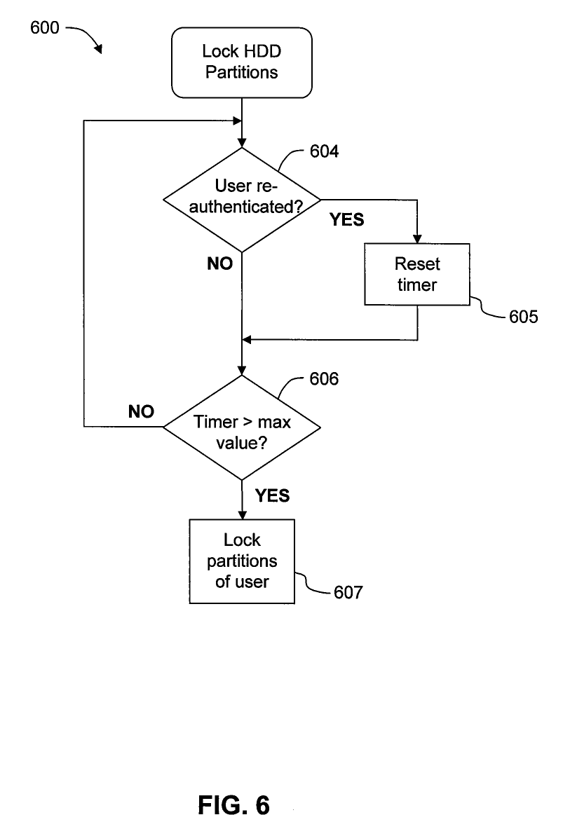

If the user is authenticated, steps 505 and 506 are carried out by the storage device. In step 505, the storage device unlocks portions of its storage media, e.g., HDD partitions, associated with the user, and enables them for access by the host. In step 506, a timer, which is used in conjunction with the method of FIG. 6, is set. In one embodiment, processor 401 in SoC 400 performs the timer function and the logical operations associated therewith. If the user is not authenticated, portions of the storage media associated with the user remain locked as indicated at step 507.

FIG. 6 is a flow diagram illustrating a method carried out by the information storage device to disable portions of the information storage device that have been enabled according to the method of FIG. 5. According to this method, the information storage device disables portions of its storage that have been enabled for access by a user if the user is not re-authenticated on a periodic basis, e.g., re-authentication may be required every 30 minutes. A timer, i.e., the timer that has been set in step 506, is used to determine whether or not the requisite time has elapsed prior to re-authentication.

In step 604, the information storage device checks to see if the user for whom portions of the storage device have been enabled has been re-authenticated. If the user has been re-authenticated, step 605 is executed and the timer is reset to zero. If the user has not been re-authenticated, step 606 is executed to see if the timer value exceeds a predetermined maximum time value, e.g., 30 minutes. If the timer exceeds the predetermined maximum value, portions of the information storage device that have been enabled for access by the user is disabled or locked by step 607. If the timer does not exceed the predetermined maximum value, flow returns to step 604.

In one embodiment, the initial user login described in method 500 requires a higher level of security than that required for user re-authentication in method 600. For example, the user login in method 500 may include an alphanumeric access code in combination with either the insertion of a smart card into a smart card reader linked to the host or the entry of a fingerprint scan, while the user re-authentication in method 600 may only require any one of the above. In addition, re-authentication is not performed with cached information and a smart card used for re-authentication is required to be inserted first and then removed. In this way, physical presence of the user is ensured for re-authentication.

When portions of a storage device being accessed by a host has been disabled or locked, an error message is returned to the host. The host may respond to such as error message in different ways. In one embodiment, the host freezes up and requires a reboot of the system. In another embodiment, the host prompts the user to log in again. Upon successful re-login by the user, portions of the storage device associated with the user are re-enabled for access.

According to an embodiment of the invention, the host does not prompt the user to re-authenticate with the storage device. The responsibility for re-authenticating with the storage device is left up to the user. For example, an icon for initiating the re-authentication process is provided on the desktop and the user double-clicks it every 25 minutes or so (assuming the re-authentication time window of the storage device is 30 minutes), with a reminder to do so being provided externally (an alarm on the user's watch or cell phone). If the user fails to re-authenticate within the re-authentication time window, the storage device silently locks up. An authorized user will not know this has happened until the next time he or she tries to access the storage device.

While the foregoing is directed to embodiments of the present invention, other and further embodiments of the invention may be devised without departing from the basic scope thereof, and the scope thereof is determined by the claims that follow.

What is claimed is:

1. A method for protecting contents of an information storage device carried out by the information storage device, comprising:
authenticating a user;
monitoring time elapsed from the time the user is authenticated; and
disabling access to portions of the information storage device associated with the user if the time elapsed exceeds a maximum.

2. The method according to claim 1, wherein the information storage device enables the portions of the information storage device associated with the user for access when the user is authenticated for the first time.

3. The method according to claim 1, wherein, after portions of the information storage device associated with the user have been enabled for access, the information storage device resets the time elapsed each time the user is authenticated.

4. The method according to claim 3, wherein the user is authenticated through a user credentials that includes one of an alphanumeric code, biometric inputs, and a smart card.

5. The method according to claim 3, wherein the user is authenticated through a user credential that includes a combination of at least two of an alphanumeric code, biometric inputs, and a smart card.

6. The method according to claim 1, further comprising:
after disabling access to portions of the information storage device associated with the user, transmitting an error message in response to a request to access one of the portions of the information storage device associated with the user.

7. The method according to claim 1, further comprising:
after disabling access to portions of the information storage device associated with the user, re-enabling the portions of the information storage device associated with the user if the user is re-authenticated.

8. A computer system comprising:
a host unit; and
an information storage device configured to: (i) enable portions of the information storage device for access by the host unit when a user has been authenticated by the information storage device, and (ii) disable the portions of the information storage for access by the host unit if the user has not been re-authenticated within a predetermined time period.

9. The computer system according to claim 8, wherein the host unit and the information storage device are components of a laptop or desktop computer.

10. The computer system according to claim 8, wherein the host unit and the information storage device are connected over a computer network.

11. The computer system according to claim 8, wherein the information storage device includes a timer that is reset each time the user is authenticated and the information storage device disables the portions of the information storage for access by the host unit if the timer exceeds the predetermined time period.

12. The computer system according to claim 8, wherein the host unit includes input devices for receiving inputs of user credentials for authenticating the user at the information storage device, the input devices including a keyboard and at least one of biometric input device and a smart card reader.

13. The computer system according to claim 12, wherein the information storage device is configured to authenticate a user based on combination of user credentials that are input through at least two of the keyboard, the biometric input device, and the smart card reader.

14. The computer system according to claim 8, wherein the host unit is programmed with an operating system that includes host-level user authentication.

15. The computer system according to claim 14, wherein the operating system issues user credentials for authenticating the user at the information storage device in response to a successful host-level user authentication.

16. A computer-readable storage medium comprising instructions that are executable by a controller of an information storage device to carry out the steps of:
authenticating a user;
monitoring time elapsed from the time the user is authenticated; and
disabling partitions of the information storage device associated with the user if the time elapsed exceeds a maximum.

17. The computer-readable storage medium according to claim 16, further comprising instructions that are executable by the controller of the information storage device to carry out the steps of:
enabling the partitions of the information storage device associated with the user when the user is authenticated for the first time.

18. The computer-readable storage medium according to claim 16, further comprising instructions that are executable by the controller of the information storage device to carry out the steps of:
after the partitions of the information storage device associated with the user have been enabled, resetting the time elapsed each time the user is authenticated.

19. The computer-readable storage medium according to claim 18, further comprising instructions that are executable by the controller of the information storage device to carry out the steps of:
after disabling the partitions of the information storage device, transmitting an error message in response to a request to access one of the partitions of the information storage device associated with the user.

20. The computer-readable storage medium according to claim 18, further comprising instructions that are executable by the controller of the information storage device to carry out the steps of:
after disabling the partitions of the information storage device associated with the user, re-enabling the partitions of the information storage device associated with the user if the user is re-authenticated.
